(19) United States
(12) Patent Application Publication
(10) Pub. No.: US 2009/0220820 A1
(43) Pub. Date: Sep. 3, 2009

(54) METHOD OF FRICTION WELDING AND FRICTION WELDED PART WITH AT LEAST TWO FRICTION WELD POINTS

(75) Inventors: Peter Kolbe, Aalen (DE); Ernst-Peter Schmitz, Abtsgmuend (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: GESENKSCHMIEDE SCHNEIDER GMBH, Aalen (DE)

(21) Appl. No.: 12/349,259

(22) Filed: Jan. 6, 2009

(30) Foreign Application Priority Data
Feb. 29, 2008 (DE) 10 2008 012 049.9

(51) Int. Cl. B32B 15/01; B23K 20/12

(52) U.S. Cl. 428/654; 228/112.1; 428/615; 428/683

(57) ABSTRACT

A method of friction welding a first part to a second part of a component having a hollow space in which the internal connection surface of the first part to be welded is reciprocally arranged with an internal connection surface of the second part to be friction welded, so that they form a unsymmetrical contact area, so that the resulting weld of the first and the second parts produces a weld bead that is located predominantly outside of the hollow space. The unsymmetrical contact area can be formed by a chamfer, angled edge surfaces that produce, for example, a wedge-shaped space, or partially matched, inter-fitting surfaces that remain out of contact at sides facing the hollow space.

### BACKGROUND OF THE INVENTION

1. Field of Invention

The present invention relates to a method for welding a first part with a second part by friction welding, wherein a hollow space in the component containing preferably small welding points is produced. The invention is also directed to a friction welded part produced according to the method of the present invention.

2. Description of Related Art

Forming of a connection between two parts by friction welding is known. Especially it is known, for example, as described in International Patent Application Publication WO 2006/034862 A1, in the case of a cooling duct piston, to connect the piston top with a piston shaft by friction welding. Also, from German Patent Application DE 10 2006 021 044 A1, it is known how to form the smallest weld beads as possible.

In certain applications, however, not only is produced a friction weld connection, but more than one connection, wherein it is very important that the internal hollow space is free of weld beads, if possible.

A typical embodiment is a piston with an oil cooling duct that should permit undisturbed oil circulation. However, all of the weld beads limiting the oil flow are disadvantageous for the cooling.

### SUMMARY OF THE INVENTION

The present invention seeks to solve the problem of the friction welding of two parts with a structural part having a hollow space by producing an exactly defined small weld bead on the weld seam in the area of the hollow space surface.

According to the present invention, this problem is solved by a method of friction welding a first part to a second part by which as few welding points as possible are formed in a structural component having a hollow space by the internal connection surface of the first part to be welded being arranged with an internal connection surface of the second part to be welded by friction welding, so that they form a non-holohedral contact area; an external connection surface of the first part to be welded being reciprocally arranged with an external connection surface of the second part to be welded by friction welding so that they form a non-holohedral contact area, and by the first and second parts being friction welded together forming an internal and external friction welded connection so that the friction weld bead is essentially developed outside of the hollow space surface.

Because neither of the parts to be welded form a holohedral contact area before the welding, but bigger contact areas are formed only during the welding process, the formation of the weld bead on the parts to be connected can be controlled and defined in an exact way.

In order to achieve a non-holohedral contact area, at least one of the connection surfaces of the first or the second part to be welded is chamfered. Because the two connection surfaces to be welded do not exactly fit one on another before the welding process, they form a small contact area which, during the welding process, advantageously grows to a maximal contact area. Both the areas of the parts to be connected can be chamfered. However, it is preferred to weld by friction welding a planar area of one part with a chamfered area of another part. The chamfered area can have very different profiles, e.g., straight-lined, concave, convex, or acute. The shape of the chamfer depends on the alignment of the welding process and also depends on which kind of weld seam is to be achieved. If the weld seam is chamfered on one side, on the peripheral side where there is less material, a smaller or no weld bead is produced. On the peripheral side where the connection surfaces to be welded contact, there is more material. A respectively bigger weld bead is formed wherein its size can not be exactly predetermined.

If the connection surface to be welded is chamfered on two sides, that is, on two peripheries considered from the cross section, the contact area is in the middle and the size of the welding seams can be defined and controlled on both sides.

According to the present invention, the problem is solved by a friction welded part produced according to one of the methods described above and so that the internal and external welding areas are chamfered on the first part and/or on the second part before the friction welding.

In this way, the width of the weld bead can be produced in a defined size towards the direction of the chamfered side. The majority of the material accumulation is on the side on which a contact area is formed before and during the welding process.

In order to reduce the weld bead to a certain size in certain applications and to have to use only certain chipping or turning tools, the connected parts are assembled at least on one side by friction welding with no weld bead or with a very small weld bead. In this way, a weld bead can be completely eliminated within a predetermined width size.

The friction welded part is preferably a part in which a weld bead in a hollow space can pose a problem, for example, in a injection pump piston, in a piston for a combustion engine with oil duct or the like.

In order to achieve a uniform expansion when the friction welded par is heated and a long life cycle and good insertion characteristics, the material of the first and the second part are identical.

In order to ameliorate the quality of the friction welded parts while implementing other requirements, and at the same time to produce a very economical friction welded part, it can be an advantage if the material of the first and the second parts are of different alloys. For example, a finished or a high strength alloy in the upper part and for the second part an inferior/softer or less expensive material can be used. It shall be understood that the alloys used are steel or aluminum alloys or a combination between steel and aluminum alloys.

In case of a friction welded part, it is preferred that it is produced according to one of the methods described above, wherein the first part to be connected is a piston top and the second part to be connected is a piston ring.

It shall be understood that the above mentioned characteristics to be explained in the following, cannot be used only in the respectively indicated combination only, but also in the other combinations.

In the following, the invention is explained in detail on basis of a piston by referring to the accompanying figures, but the present invention is not intended to be limited thereto.

### BRIEF DESCRIPTION OF THE DRAWINGS

FIG. 1 shows sectional views of two piston parts to be connected with the method of the present invention and the two piston parts after they have been connected;

FIG. 2 is a sectional view of a peripheral portion of the piston parts of FIG. 1 in the area of encircled detail A, prior to and after the formation of weld beads;

FIGS. 3-9 are views like that of FIG. 2, but showing various other embodiments of the invention.

### DETAILED DESCRIPTION OF THE INVENTION

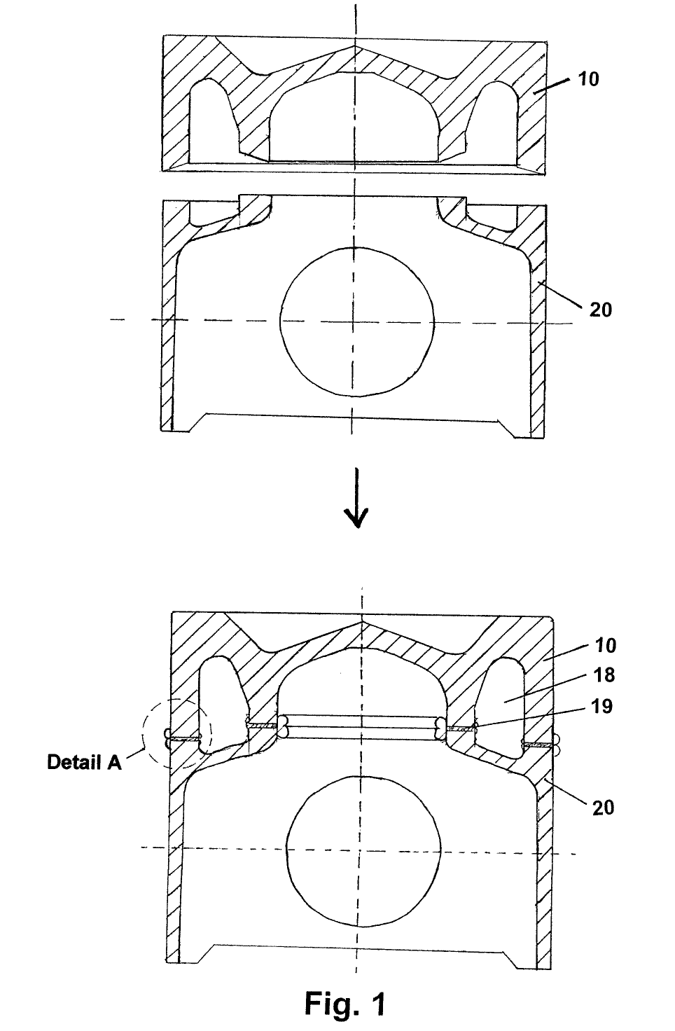

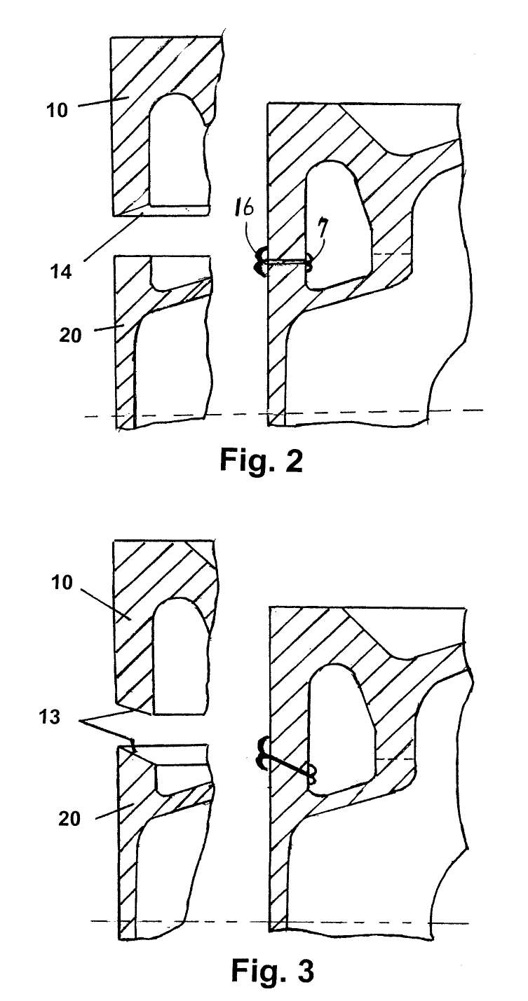

The upper portion of FIG. 1 schematically shows a cross section of the top part 10 of a piston head and of a lower part 20 of the piston head, one over the other, before the welding process. The chamfer of the walls to be welded is clearly shown at the lower edges of the top part 10 of the piston head, so that the material accumulation during the friction welding process is formed outside of the oil duct 18. The upper part 10 of the piston according to this embodiment shows the special design of an external chamfered welding surface 14 on the top part 10, as shown in detail in FIG. 2. This chamfered welding surface 14 is put on a planar welding surface of the lower part 20 of the piston during formation the connection of the part 10, 20 by friction welding. As a result, there is a wedge-shaped gap before the friction welding. As a consequence, the contact areas of the top part 10 and lower part 20 to be welded do not completely fit one on the other. The holohedral (symmetrical) connection is only formed by the friction welding process with the result is that, there is less material 7, 19 on the sides of the edges facing into the duct 18 than on the opposite sides. The wedge-shaped gap form an angle of approximately 4-15°, preferably of approximately 5-10°, and most preferably of 7.5°.

FIG. 2 shows that a weld bead 16 is formed in a traditional way on the external part of the piston. In contrast, the friction weld bead 7 on the internal side has a substantially smaller size. In this way, according to this embodiment, a good cooling oil flow inside the oil duct is guaranteed.

FIG. 3 shows a section of an external wall of a piston in accordance with a second embodiment before and after the friction welding process. In this case, the external wall of the piston is shaped so that both of the facing edge surfaces 13 to be welded are arranged in an inwardly downward angle so that the material accumulation is formed on the external area of the piston.

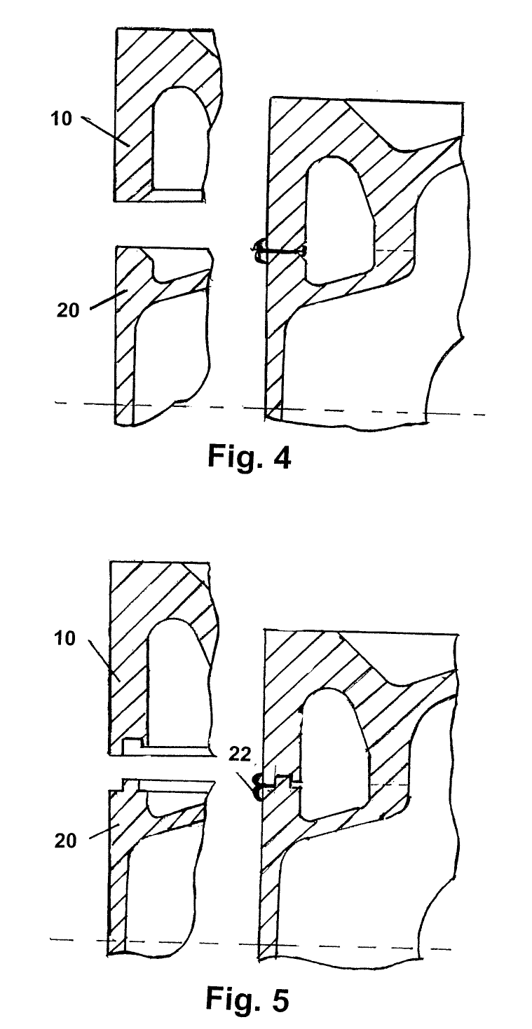

FIG. 4 shows a section of a third embodiment of an external wall of a piston before and after the friction welding process. In this case, there are chamfers that create a recess in the area of the oil duct inside the piston walls, and in which the material of the weld bead can be accumulated after without limiting the internal width of the oil duct.

FIG. 5 shows a section of a fourth embodiment of the walls of the top and lower parts 10, 20 of the piston. Here, the facing edge surfaces have nearly matched inter-fitting profiles, the inner sides of which remain out of contact, as shown, both before and after the friction welding process, so that there is substantially less material accumulated in the area of the oil duct.

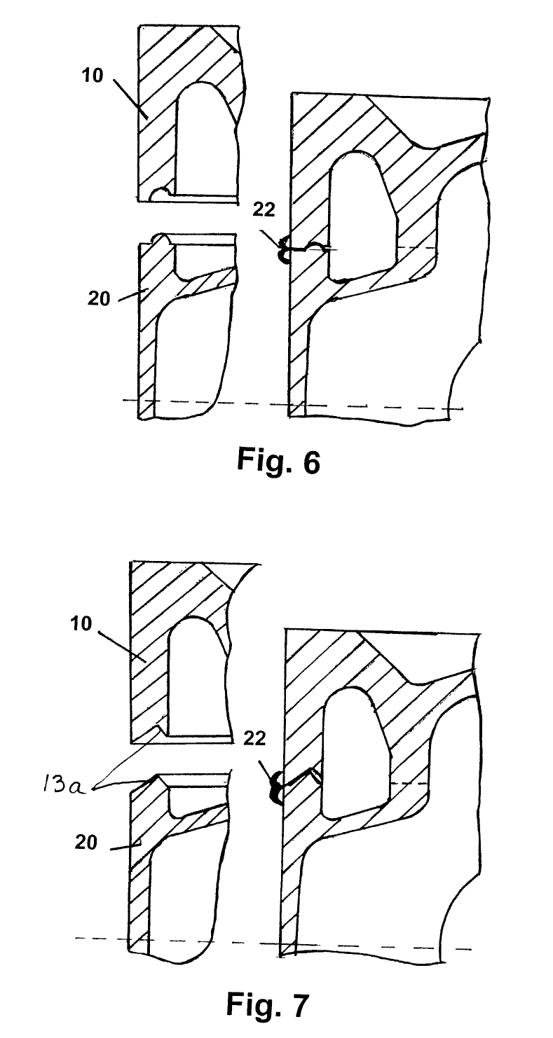

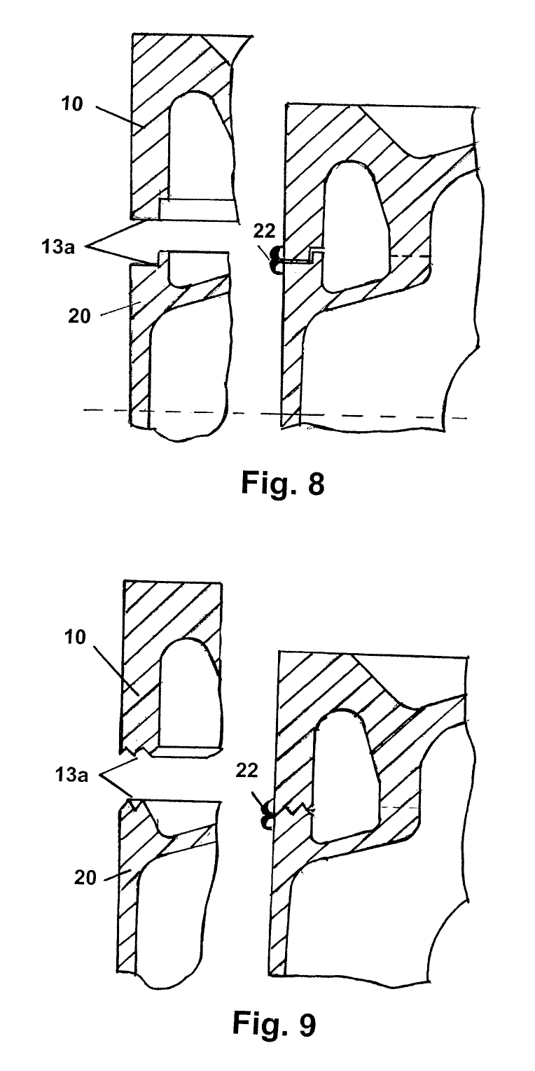

FIG. 6 shows a similar concept to that of the FIG. 5 embodiment, the profiles being rounded instead of stepped. Here again, the inner sides of the inter-fitting profiles of the external wall of the piston parts 10, 20 remain out of contact, as shown, both before and after the friction welding process.

FIG. 7, 8 and 9 show sections of other embodiments of top and lower parts 10, 20 of a piston with inter-fitting profiles in which the inner sides of the inter-fitting profiles 13a of the external wall of the piston parts 10, 20 remain out of contact, as shown, both before and after the friction welding process and which are suitable for the friction welding with the material accumulations 22 of the welding process always being formed on the external wall of the piston.

As a consequence, the volume of the cooling duct 18 has no problems due to restricted volume and the friction weld bead 22 can be easily checked from outside by the piston. As a consequence, components which are faultily friction welded can be determined very quickly.

On the basis of the requirements, the material that the top part 10 is produced from can be a high strength or resistant material, for example, steel or aluminum. On the other hand, the lower part 20 can be produced from a more flexible or inferior steel or aluminum. For the rest, we refer to the figures depicting the invention as essential parts of thereof.

1. A method of friction welding a first part to a second part to produce a component having a hollow space formed in the component, comprising the steps of:
arranging a contact area of an internal connection surface of the first part to be welded with respect to an internal connection surface of the second part and arranging an external connection surface of the first part to be welded relative to the second part to be welded so that they form an unsymmetrical contact area, and
producing a friction welded connection between said connection surfaces of the first and second parts so that a friction weld bead resulting therefrom is at least predominantly located outside of the hollow space.

2. The method according to claim 1, wherein the unsymmetrical contact area is formed by providing at least one of the connection surfaces of the first and second parts to be welded with one of angled, concave, convex, chamfered and irregularly profiled shape.

3. The method according to claim 2, wherein the irregularly profiled shape is provided on the connection surfaces of both of the first and second parts to be welded, the irregularly profiled shape of the connection surfaces of the first and second parts being configured to inter-fit with each other, and wherein the irregularly profiled shape of the connection surfaces of the first and second parts are interfit with each other with a portion of the inter-fit shapes of the connection surfaces of the first and second parts being maintained out of contact with each other in an area adjoining the hollow space both before and after the friction welded connection is produced with the remainder of the connection surfaces.

4. The method according to claim 1, the contact surfaces on at least one of the first part and the second part are chamfered before producing of the friction weld.

5. The method according to claim 1, wherein the first part to be connected is an upper part of a piston head and the second part to be connected is a lower part of a piston head.

6. Friction welded part produced according to the method claim 1, in which the connected parts have no weld bead at one side of the welded connection.

7. Friction welded part produced according to the method of claim 1, wherein the component is a piston for a combustion engine and wherein the hollow space is a cooling duct.

8. Friction welded part produced according to the method of claim 1, wherein the first and second parts are made of the same material.

9. Friction welded part produced according to the method of claim 1, wherein the first and second parts are made of different materials.

10. (canceled)

11. Friction welded part according to claim 6 wherein the top part is made of a high strength or resistant steel or aluminum and the lower part is produced from a more flexible or inferior steel or aluminum.
